(19) United States
(12) Patent Application Publication
(10) Pub. No.: US 2009/0003924 A1
(43) Pub. Date: Jan. 1, 2009

(54) Opening and Closing Mechanism II

(75) Inventors: Gustaf Unoson Rylander, Falsterbo (SE); Karl-Axel Wittsel, Vellinge (SE)

Correspondence Address: BROOKS KUSHMAN P.C., 1000 TOWN CENTER, TWENTY-SECOND FLOOR, SOUTHFIELD, MI, 48075, US

(73) Assignee: AB METALLMEKAN, Vellinge (SE)

(21) Appl. No.: 12/160,249

(22) PCT Filed: Dec. 27, 2006
(86) PCT No.: PCT/SE06/01496

§ 371 Date: Jul. 8, 2008

(30) Foreign Application Priority Data
Jan. 9, 2006 (SE) 06000036-8

(51) Int. Cl. B42F 13/00

(52) U.S. Cl. 402/73

(57) ABSTRACT

A binder has a device for opening and closing a binder for storing sheets with at least one mechanism arranged in the area of the back of the binder. The mechanism comprises at least two spaced-apart strips which are movably interconnected by at least one common hinge, which strips are adapted for connection to the binder and are movably connected to a link means in such manner that the opening and closing motion of the binder produces a simultaneous positively guided motion of the hinge means. The link means comprises a pivot means which is pivotally connected to a centre strip of the hinge means via a centre axis which is a first pivot centre and which extends substantially transversely to the longitudinal direction of the back of the binder.

### FIELD OF THE INVENTION

The invention relates to binders for storing sheets and more specifically to a device for opening and closing a binder with a mechanism arranged in the area of the back of the binder. The mechanism comprises at least two spaced-apart strips which are movably interconnected by at least one common hinge and adapted to be connected to the binder.

### BACKGROUND OF THE INVENTION

There are a number of different prior-art mechanisms for opening and closing storage binders as well as different binder systems. The binders have various types of hinges and leaf-holding means, often in the form of forks or half-rings, depending on where in the world they are used since there are different national and regional standards for hole patterns, sheet size, dimensions and systems of measurement. The Swedish binder and hole pattern system differs, for instance, from the European systems which, in turn, are different from that of, for instance, the US and Asia. What is more, some countries use several different binder and hole pattern systems. Finland, for example, uses both the Swedish and the European systems.

In Germany, for instance, use is made, among others, of a binder system with an opening and closing mechanism having two positions: a position in which the binder and the mechanism are closed, and a position in which the binder is fully open or unfolded and is in a substantially lay-flat position for inserting and/or taking out sheets by manual separation of the mechanism holding the sheets in place. This binder system uses two divided spring-loaded or positively guided rings, onto which sheets are slipped using their holes corresponding to the rings, and a fixed plate and a detachable plate which can be displaced along the rings and fastened thereto by an integrated locking mechanism.

Sweden uses a binder system for essentially two different types of binders: a binder type having a divided back to provide a hinge function, in which the back is in most cases made of wood, plastic or paper, sometimes also metal, and a binder type having a full and unbroken back, in which the binder is often and for the most part made of plastic and/or paper or other materials and in which the opening and closing mechanism is also the hinge.

The opening and closing mechanism used in the Swedish binder system serves to provide two end positions, open or closed, and one or more intermediate positions in which the opening and closing mechanism can be partially open to allow the user to leaf through the binder and to make the turning of the pages easier without making it necessary for the user to open the binder completely.

In Sweden, there are, among others, a binder model called ERGOGRIP® or, alternatively, just ERGO® supplied by KEBA, SWEDEN. This binder is made of plastic and has a divided back functioning as a hinge for an opening and closing mechanism made of metal. The products AGRIPPA and JOPA provide binders similar to the above-mentioned ERGOGRIP® binder, with the difference that the binder backs are made of metal or wood.

The above-described opening and closing mechanism, which has an opening and closing function while functioning as a hinge and taking over the hinge function of the divided binder back, is essentially available in two versions: a version referred to as half back with a mechanism for thin binders, and a version referred to as full back with a mechanism for thick binders.

Prior-art mechanisms for opening and closing storage binders suffer from several drawbacks. First of all, manufacturers of binders and/or opening/closing mechanisms have to construct and manufacture different types of mechanisms in different countries and use completely different ways of assembling the mechanisms in the binders. This reduces the possibilities of using the same tools, the same know-how and in some cases the same materials, and there are very seldom any synergy effects to be gained.

The above-described mechanism having both an opening/closing and a hinge function is further used in binders with a rigid and unbroken back. This mechanism has a substantially U-shaped cross-section with the hinge in the centre of the bottom of the U and the entire mechanism is fastened with the legs of the U to the sides or side portions of the binder. The legs of the U can be fastened to the inside and/or outside of the binder. The problems arising from this type of mechanism in a binder having an unbroken, undivided back are that the mechanism pivots about a pivot axis by the hinge function whereas the pivot axis of the hinge is not aligned with the pivot axis of the sides of the binder since the binder is made so as to be unfolded to a substantially lay-flat position, thus rotating/pivoting to a limited extent only. Due to its shape and attachment to the mechanism, the unbroken/rigid back of the binder thus resists/“counteracts” the natural opening motion of the binder when the back is deformed as the sides of the binder are being unfolded and when the sides are in a lay-flat position.

The above-mentioned drawbacks have a physical impact on the user who has to use more force than necessary to open the binder, which is annoying. This also reduces the life and durability of the binder as well as the aesthetic appearance of the binder back when the binder is deformed, which may, for example, result in crack formation and reduced strength of the binder. This also means that any information printed on the outside of the binder back may be destroyed and that it may be difficult to print anything thereon. This is particularly common in the case of binders with a wooden back since the binder back is often covered by fabric which functions as a hinge by keeping the back of the binder together. The wooden binder back is divided, which also makes it difficult to print thereon, reduces the printable area and impairs print exposure.

Another drawback is that, when forks or pins are used in prior-art opening and closing mechanisms with both an opening/closing and a hinge function in binders with undivided/rigid back, the binder is not opened wide enough owing to the above-described force which counteracts the opening motion as the binder back is being deformed. This insufficiently opened binder, with too small a free distance between the outermost freely projecting fork ends, makes it very difficult to slip the sheets onto the forks, the user often having to keep the forks apart or pressing them further apart with one hand at the same time as he is trying to align the holes of the sheets with the forks with the other hand.

One of the Applicant's Swedish patent applications No. 0301868-6 relates to a mechanism for opening and closing a binder for storing sheets with a mechanism which is arranged at the inside of the binder and which comprises two strips, which are movably interconnected by at least one common hinge. The mechanism also comprises a hinge strip which allows a strip to move on the common hinge by means of a guide pin running in a slot.

There are several disadvantages of the above-mentioned hinge strip mechanism. It is, among other things, complex and difficult to mount in the binder as it comprises several separate components, which means many “unnecessary” mounting operations and results in a “less satisfactory” function owing to relatively large/long displacements of the guide pin in the slot and “important” friction between the guide pin and the hinge strip. The hinge strip mechanism thus generates more noise in use due to the guide pin “scraping” against the slot, and the guide pin also wears down against the slot, so that material is used up from both the pin and the slot, which causes the sheets of paper stored in the binder to get dirty/“dusty” from grinding dust. The function of the hinge strip mechanism also deteriorates over time by the wear between the guide pin and the slot as the gap between them increases. The hinge strip mechanism also counteracts and obstructs the leafing through of the sheets since it is asymmetric and thus loaded on only one side in use, i.e. the sheets of paper fall back to the “closed” position when leafed through and the turning of the sheets requires a major manual effort to actively move the sheets.

### SUMMARY OF THE INVENTION

The principal objects of the present invention is to provide an opening and closing mechanism which is easy to use, strong, reliable, flexible and versatile in such manner that it can be arranged in a number of different types of binders storing documents, sheets with pockets for photos or storage media in the form of, for example, CDs, data diskettes, in particular storage binders with an unbroken or rigid back irrespective of hole pattern and fork type.

These objects are achieved by the invention by using a device of the kind stated by way of introduction, which has the features specified in claim 1 with preferred embodiments disclosed in the appended dependent claims.

According to the invention, a device is provided for opening and closing a storage binder with a mechanism which is arranged in the area of the back of the binder and which comprises at least two spaced-apart strips for connection to the binder, which strips are movably interconnected by at least one common hinge. The mechanism comprises a link means which is movably connected to a centre strip of the hinge, which hinge also comprises two outer strips which are movably connected to the centre strip of the hinge. The outer strips of the hinge are movably connected to the link means in such manner that the opening and closing motion of the binder produces a simultaneous positively guided motion of the hinge.

The link means comprises a pivot means which is movably connected to the strips of the hinge in such manner that the opening and closing motion of the binder produces a positively guided motion of the pivot means and the outer strips of the hinge in another preferred embodiment of the device.

The link means is pivotally connected to the centre strip of the hinge means via a centre axis which is a first pivot centre, the centre axis extending substantially transversely to the longitudinal direction of the back of the binder.

In an alternative embodiment of the device, the outer strips of the hinge are connected to the centre strip of the hinge by a respective hinge which extends along the back of the binder.

In a further embodiment, the pivot means is movably connected to the outer strips of the hinge means via at least one link arm for each outer strip. In another embodiment, the link arms of the pivot means comprise first ends which are movably connected to the pivot means at different sides of its centre. In yet another embodiment, each link arm extends towards the associated outer strip and the second end of each link arm is movably connected to the associated outer strip, and in yet a further embodiment the link means is provided with a pivot centre for each first end of the link arms.

In another embodiment, the link means comprises a locking mechanism which comprises at least one recess which is arranged on the circumference of the link means and adapted for detachable engagement with at least one projection which is in operative connection with a thumb grip which is connected to the centre strip of the link means so as to allow stepwise rotation of the link means when disengaging the projection by the thumb grip and to provide locking of the link means and thus the binder in a desired position when the projection is engaged with the intended recess.

In addition to the advantages of prior-art opening and closing mechanisms, i.e. the possibility of quickly and easily leafing through the documents and the pages with photos or storage media without having to remove them and risking that they will disappear or end up in the wrong order after having been taken out of the binder and then put back again, the opening and closing mechanism for binders according to the above-described invention also has the following advantages: it can be stored and used as a module, i.e. it can among other things be used both in a binder according to the Swedish binder and hole pattern system and in a binder according to, for instance, the European binder and hole pattern system; it is aesthetically more pleasing to use in connection with binders with a full back since publicity and text as well as labels for this purpose at the outside of the back are not bent or deformed and the printing surface is unbroken and bigger than in the case of binders with a divided back; binders with a full back thus have a longer service life; and the user of this mechanism can open the binder more easily using less force. This mechanism also functions in a more silent and “flexible” way compared to prior-art mechanisms, with less friction between the movable parts as compared, for instance, to the Applicant's prior-art hinge strip mechanism. Furthermore, modern printing technique can be used for printing compared to, for example, the prior-art wooden back binder. Moreover, the mechanism is easier to mount in a binder since the use of fewer loose components, for instance no separate hinge strip, means shorter and fewer working moments. Since the mechanism according to the invention is complete and can be handled as a unit with its parts stuck together, it is also more handy and easy to use. In addition, less material is used when manufacturing the mechanism according to the invention.

### BRIEF DESCRIPTION OF THE DRAWINGS

The present invention will now be described in more detail with reference to the accompanying drawings, in which

FIG. 1 is a perspective view of a binder mechanism according to the invention in a closed position,

FIG. 2 is a top plan view of the binder mechanism according to FIG. 1,

FIG. 3 is a top plan view of the binder mechanism according to FIG. 2 in a fully open position,

FIGS. 4-6 are top plan views of the binder mechanism according to FIGS. 1-3 during opening of the same, and

FIGS. 7-9 are bottom plan views of the binder mechanism according to FIGS. 1-3 during opening of the same.

### DETAILED DESCRIPTION OF THE INVENTION

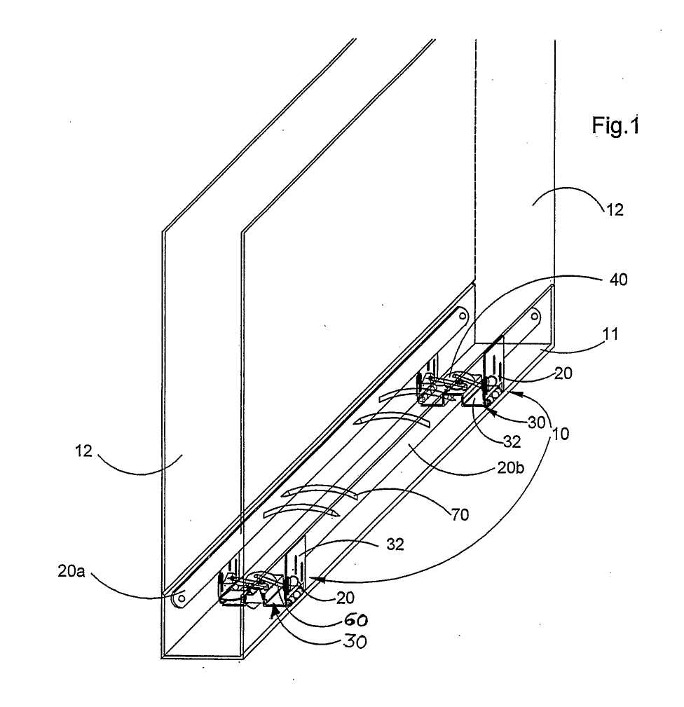

An opening and closing mechanism 10 according to the invention, for use in a partially shown binder in which can be stored hole-punched documents or pages/sheets of plastic and/or paper with pockets for storing photos or, for instance, CDs and data diskettes, will be described in the following with reference to FIGS. 1-9.

FIGS. 1-9 show the opening and closing mechanism 10 when mounted at the inside and/or outside of a binder, said mechanism, for the sake of simplicity, hereinafter being referred to as the binder device 10 and the documents/storage sheets, for the sake of simplicity, being referred to as binder pages.

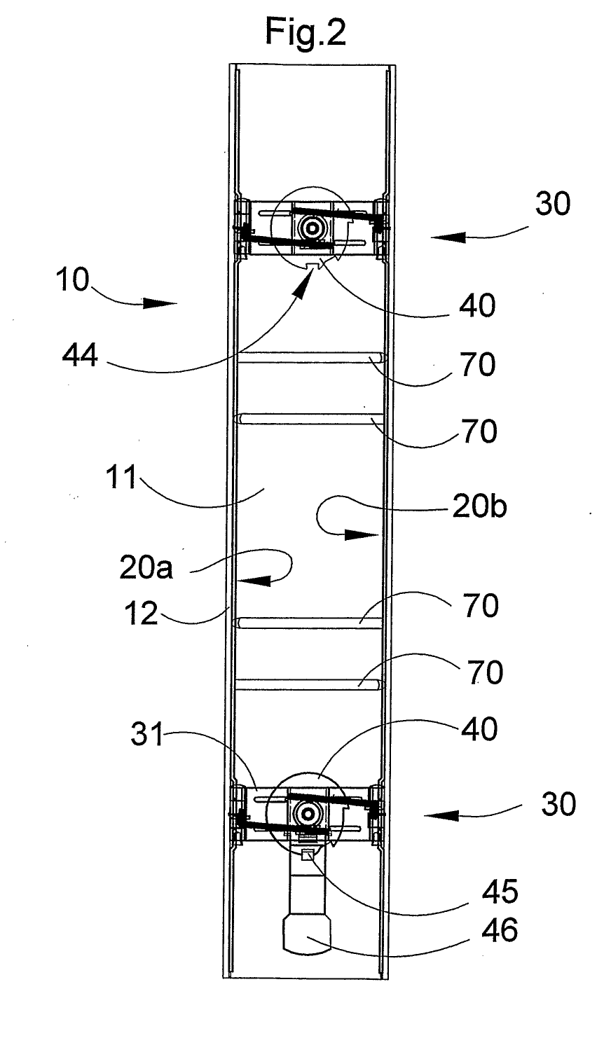

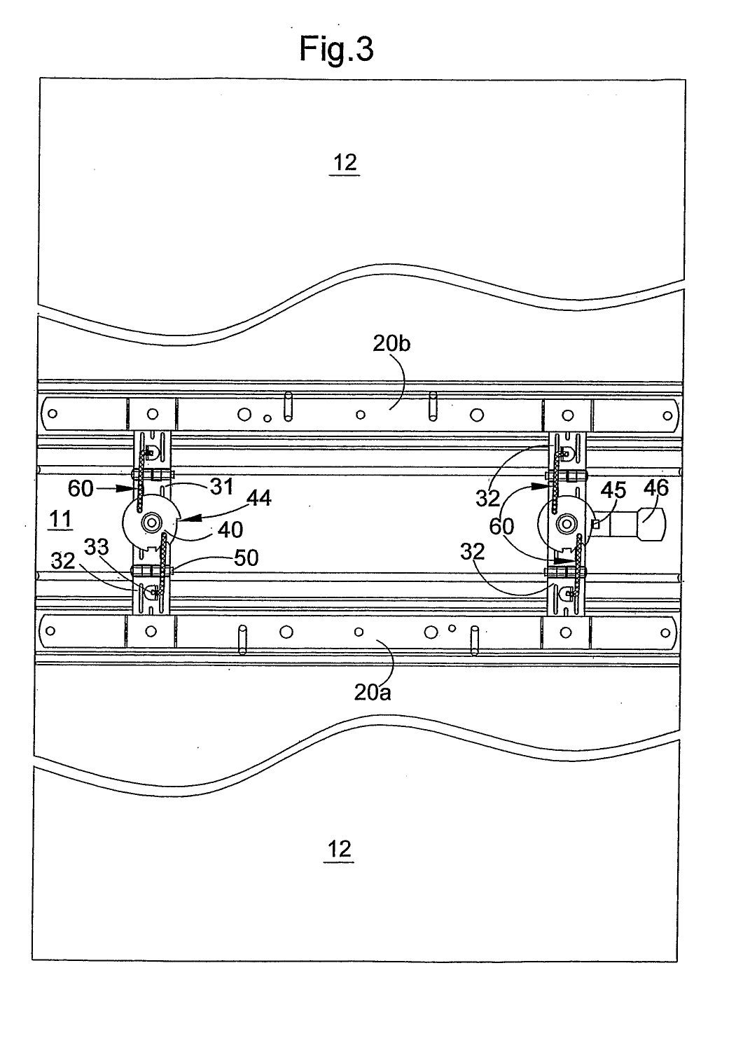

In FIGS. 1-3, this binder device 10 is shown in two different positions: a closed and a fully open position. FIG. 1 is a perspective view of the binder device in an end position for storage of binder pages, i.e. a fully closed position, FIG. 2 shows the same position as in FIG. 1 but in top plan view, and FIG. 3 shows the binder device in an end position in which the binder pages can be received for storage in the binder and/or removed from the binder, i.e. a fully open and unfolded/lay-flat position. For the sake of clarity, the binder is shown as transparent.

The binder device 10 is placed at the inside and/or outside of the binder adjacent the back 11 of the binder and is adapted to fit into binders of various thicknesses and to constitute a reinforcing structure for the back of the binder. The binder has sides or side portions 12 functioning as an extension of the binder device 10. The binder device also comprises a mechanism 20 which is mountable in the binder and which, in turn, can comprise elongate strips extending along the inside and/or outside of the back of the binder, said strips being two substantially opposite and mirror-inverted elongate strips, of which one strip 20a is arranged to the left and one strip 20b to the right, as shown in FIG. 1. The strips are movably interconnected by two common hinge means, i.e. pivot/opening/joint means 30, and mutually spaced-apart. An alternative solution would be to use one hinge only or more than two, depending on the desired strength, material consumption and stability. The strips and the opening hinges are preferably made of metal, for example steel or aluminium, but they can also be made of other sufficiently strong and rigid materials.

The opening hinge 30 according to the invention is partly similar to a flat chain comprising three flat links, strips or sections, a centre section 31 and two outer sections 32 in the form of two substantially opposite and mirror-inverted strips. A link means 40 in the form of a guiding or pivot means is arranged approximately in the middle of the centre section 31 of the opening hinge 30 and is movably connected to the outer sections 32 of the opening hinge 30. A first end 32a of each outer section 32 is movably connected to the centre strip 31 via a pivot hinge 50, which extends along the back 11 of the binder, so that the two outer sections 32 can move, i.e. pivot or rotate freely in relation to the centre section 31 in a plane substantially parallel to the opening and closing motion of the binder, and the outer sections 32 have a second end 32b projecting from the centre section 31 for optional connection either to the associated strip 20a or 20b or directly to the associated binder side portion 12.

The pivot means 40 is a guiding plate which is preferably circular with a flat shape but it can also be an elongate component part, for instance elliptic, or be formed as a bar, a beam or an arm. The plate 40 can also be asymmetric, i.e. have a non-uniform shape, for instance, have a comb-like shape, or an elongate shape with projecting members of different lengths if it is desirable to make the motion of the associated outer section 32 longer or shorter than the motion of the other outer section.

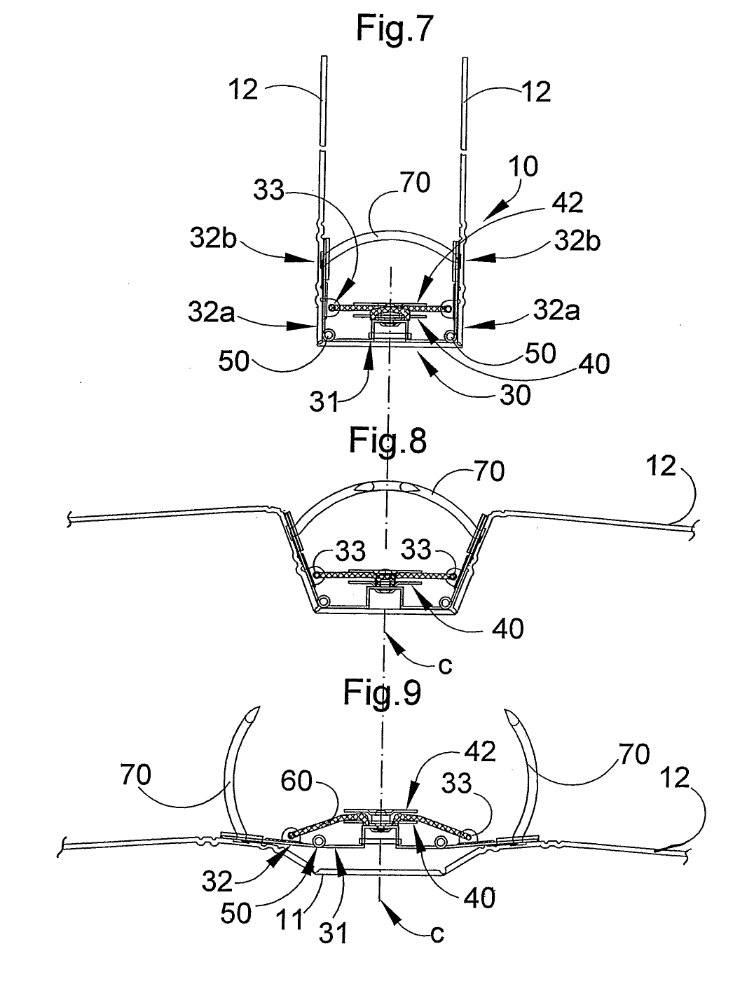

FIGS. 7-9 are plan views, seen from the underside of the binder, showing different positions of both the side portions 12 of the binder and the parts of the binder device 10 during opening and closure of the same. The respective strips 20a, 20b extend along the inside and/or outside of the binder at the back 11 of the binder and in the longitudinal direction of the back of the binder and provide a substantially right-angled profile seen from the underside of the binder, and more specifically a substantially U-shaped cross-section together with the centre section 31 and the outer sections 32 of the opening hinges 30 seen from the underside or top side of the binder, in the fully closed position shown in FIGS. 1, 2, 4 and 7. The strips are interconnected at a respective end or leg of the U by means of the opening hinges 30 in such manner that the pivot hinges 50 are located in the corner areas in the transition between the back 11 of the binder and its side portions 12, according to FIGS. 1 and 7, when the binder is fully closed.

In this embodiment, the binder device 10 in FIGS. 1-9 is fastened to the inside of the side portions 12 of the binder by fastening means in the form of rivets which keep the strips 20a, 20b in direct contact with the binder. In another embodiment, the outer sections 32 of the opening hinge can instead be fastened directly to the side portions 12 of the binder and/or to the outside of the binder, in which case they replace/eliminate the strips 20a, 20b.

The binder device 10 is usually provided with one or more cooperating pairs of forks or half-rings 70, as shown in FIGS. 1-9, which are attached to the strips 20a, 20b to hold pages that are to be stored in the binder in a manner known by a person skilled in the art and therefore not explained further.

The guiding plate 40 is preferably formed as a symmetric plate, which is movably fastened in the centre to the centre section 31 of the opening hinge via an axis C, as shown in FIGS. 7-9, said axis C extending substantially transversely to the longitudinal extension of the back of the binder. The guiding plate is movably connected to the outer sections 32 of the opening hinge by link arms 60, at least one link arm for each outer section. The guiding plate 40 is pivotally connected to the opening hinge 30 via a pivot centre in the form of the centre axis C.

Each link arm 60 has a first end 60a, which is movably connected to the guiding plate 40, and a second end 60b, which is at least partially movably connected to a projecting part 33 in the form of projecting lugs on the associated outer section 32, whereby the guiding plate 40 constitutes a movable connection between the outer sections 32 of the opening hinge. The attachment lugs 33 are arranged at a suitable distance from the end 60a, 60b of the associated outer section and project a suitable distance substantially at right angles from the respective outer sections. Each first end 60a of the two link arms is fastened to the guiding plate 40 at different sides of the pivot axis C of the guiding plate at preferably the same radial distance from the axis C.

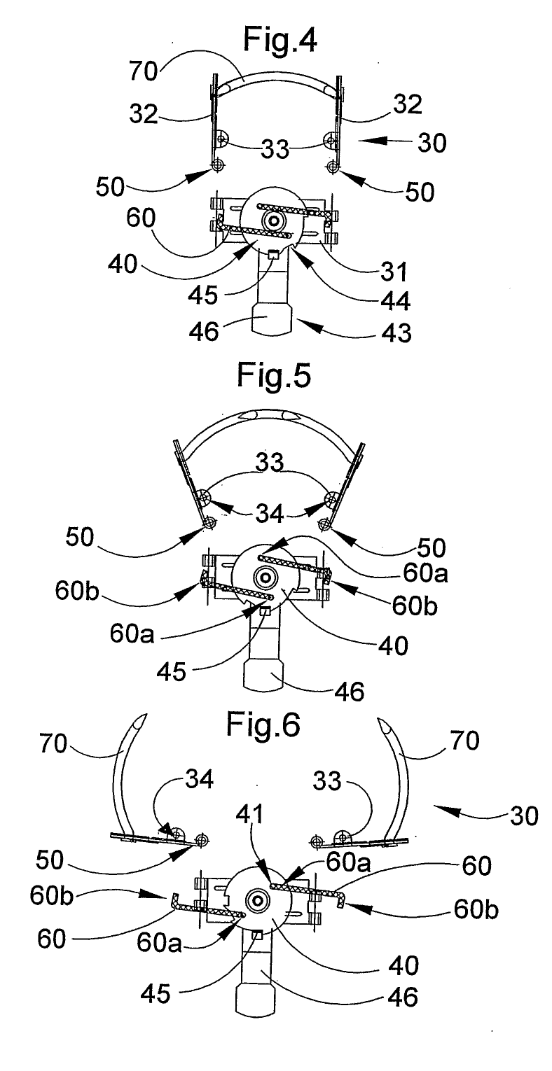

FIGS. 4-6 show the guiding plate 40 according to the invention, the first link arm ends 60a being fastened thereto in a manner such that when the binder is closed and opened the guiding plate 40 pivots and the first link arm ends 60a follow the pivoting of the guiding plate. When moved, the link arm ends 60a make a sweeping motion in a bent/curved shape substantially corresponding to the motion of the guiding plate, and in this case also corresponding to its circumference, and move about the pivot centre C of the guiding plate at the same radial distance. The movable connection between the guiding plate 40 and the link arm ends 60a is provided by a pivot centre in the form of a hole or an opening 41, one for each link arm end, into which hole the link arm end fits for movable/pivotal engagement so that each link arm end can pivot in the hole 41 when the binder is opened and closed. In this embodiment, the attachment holes 41 are placed at the same radial distance from the centre C of the guiding plate but they can also be placed at different distances from the centre of the guiding plate. Each hole 41 can be provided with a bearing in the form of, for instance, a plastic bushing or the like to further reduce the friction between the movable parts.

The link means 40 thus has a first pivot centre to pivot about its own axis C and two pivot centres 41 for the first ends 60a of the link arms, i.e. a pivot centre for each link arm end 60a. The pivot centres C, 41 are geometrically fixed in relation to each other to produce the positively guided motion of one or more opening hinges 30 when the binder is opened and closed.

The link arm end pin 60 is formed with an end that is bent in an angle and slipped through the hole 41 for engagement therewith and is then kept in place by a second plate 42 which is fixedly connected to the opening hinge 30 and placed over the guiding plate 40 to cover the same substantially parallel thereto at such a distance that the link arm end pin 60 cannot be detached by mistake by being moved perpendicularly to the plane of the guiding plate such a long distance that the link arm end pin disengages from/“falls out” of its engagement with the guiding plate 40. The covering holder plate 42 can have a shape substantially corresponding to that of the guiding plate or be smaller or bigger/covering or have a different non-corresponding shape. The second ends 60b of the link arms are connected to the attachment lugs 33 in a manner corresponding to that of the first link arm ends 60a, i.e. by movable engagement in similar attachment holes 34.

The purpose of the guiding plate 40 shown in FIGS. 1-9 is to guide the motion of the opening hinge 30 and its sections 31, 32, i.e. to positively guide at two sides and synchronise the motion of the opening hinge, i.e. the relative motion of its outer sections 32, simultaneously and synchronously with the motion of the side portions 12 of the binder and make it possible, when a user of the binder wishes to open or close the same, to “flatten” the binder as much as possible in the fully open position, according to for instance FIG. 3, without preventing or obstructing the separation or the compression as the user of the binder manually opens and closes the binder.

The advantage of an opening hinge 30 having two pivot hinges 50 and being movably connected to the guiding plate 40 is that the binder device 10 allows the binder to be opened and folded out without any deformation of the back of the binder since the link connection in the form of the guiding plate 40 and the link arms 60 allows the binder device 10 to maintain its pivotal motion and pivot axis at the same time as the binder maintains its pivotal motion and pivot axis and shape, and thus these different motions do not counteract each other and the shape of the binder does not obstruct the motions due to deformation when the binder is completely opened.

The guiding plate 40 and its link arms 60 are formed such that the motion of the binder, and thus the opening hinge 30, is guided when closing the binder, in such manner that the centre axis C of the guiding plate does not coincide with or is not completely aligned with the longitudinal axis of the link arms 60, which means that the closing motion of the binder is not “blocked” since the link arms are not “pressed through” the pivot centre C of the guiding plate straight towards the centre but always produce a moment of force about the pivot centre C when the binder is closed.

The holes 41 of the guiding plate 40 are shown in FIGS. 4-6 and are placed at a constant distance from the centre of the guiding plate, i.e. its pivot axis C, at different/opposite sides of the axis C. The holes 41 are arranged so as to follow the circular motion of the guiding plate within the respective halves of the plane of the circle, i.e. if the guiding plate 40 is circular a hole 41 is placed so that the associated link arm end 60a is limited by and moves only within the first and fourth quadrants of the circle, and the other hole 41 is placed so that the associated link arm end 60a is limited by and moves only within the second and third quadrants of the circle when the binder is opened and closed. This movement pattern implies that each link arm end 60a follows the motion of the link means and “sweeps” an arc or an area of a part circle, irrespective of whether the guiding plate 40 is circular, asymmetric or elongate, and the attachment holes 41 sweep an area corresponding to the extension of a slot, the movement pattern of each link arm end 60a being limited by this sweeping arc motion/extension. Owing to the placement of the holes 41, the guiding plate can pivot between its end positions, i.e. between the fully closed and the fully open positions of the binder without being “blocked”/obstructed. The design and placement of the holes 41 depend on the dimensions and geometric motion and the placement of the opening hinge 30 and the link arms in the binder in relation to the strips 20a, 20b, each other, the attachment lugs 33, and the design of the binder, thereby ensuring that the movable parts are not blocked in relation to each other.

The link arms 60 of the pivot means extend away from each other towards the associated outer strip 32, and the first ends 60a of the link arms preferably move in a plane or in a direction extending in an arc along the circumference of the guiding plate 40 substantially in the direction or plane of the opening and closing motion of the binder, i.e. the horizontal plane if the binder is lying down horizontally or the vertical plane if the binder is standing up vertically. The arc-shaped motion of the first ends 60a of the link arms is always provided in the direction of the opening and closing motion of the binder.

The link arms 60 are made by rolling or bending using a suitable method to obtain the right shape and increased strength. They are made of wire material but can also be made of round bars or other types of bars, such as square bars, or be made of other suitable initial materials with some other profile/cross-section, for instance flat cross-section, such as sheet-metal material.

The motion of the opening hinge 30 is guided by the link arms 60 of the guiding plate “holding” the outer sections 32 of the hinge so that they cannot pivot freely in the “wrong” direction but are forced to perform a positively guided and synchronised but opposed motion during the opening/closing motion of the binder, i.e. a two-sided positively guided motion by the pulling of one link arm simultaneously causing the pushing out of the other link arm.

In FIGS. 2-6, a locking mechanism 43 is shown adjacent the lower opening hinge 30. The purpose of this mechanism 43 is to allow a user of the binder to open and close the binder by a connectable and disconnectable engagement in the form of at least one recess 44 on the circumference of the link means 40, said recess being adapted for engagement with at least one movable projection in the form of, for instance, a spring-loaded latch 45. The latch 45 can be arranged on and be operated by a spring-loaded thumb grip 46 in a manner known per se, and therefore the thumb grip will not be described in detail here. The guiding plate 40 can be formed with one or more recesses 44 along its circumference/outer edge which are adapted for locking engagement with the latch 45 of the thumb grip, and the placement of the recesses on the circumference of the guiding plate defines the closed/open position and/or the leafing-through position of the binder so that the guiding plate can be “restrained” and allow one or more intermediate positions/leafing-through positions of the binder during opening/closing.

The link means 40 according to the invention comprises at least one locking mechanism 43 which has a function essentially similar to that of a lock coupling, i.e. a separately operating overrunning clutch of the type locking pawl mechanism which allows selective, stepwise rotation of the guiding plate 40 in two directions. The locking mechanism 43 is adapted to allow stepwise rotation of the guiding plate and to lock the plate, and thus also the binder, in a desired position.

The locking mechanism 43 comprises at least one recess 44 which is arranged on the circumference of the guiding plate 40 and which is adapted for disconnectable engagement with at least one latch 45 which is in operative connection with the thumb grip 46. The thumb grip is connected to the centre strip 31 of the guiding plate in such manner that the guiding plate 40 can be rotated stepwise when the latch 45 is disengaged/disconnected by the thumb grip 46 and the guiding plate can be locked, and thus also the binder, in the intended position when the latch 45 is engaged with the intended recess 44.

The locking mechanism 43 allows stepwise rotation, for instance, stepwise from a first recess 44 intended for the closed position of the binder to a second recess 44 for the open position of the binder and back or stepwise from a first recess 44 intended for the closed position of the binder via one or more second recesses 44 for the leafing-through position/-s of the binder to a third or last recess 44 for the open position of the binder and back when the latch 45 is disconnected from its engagement with the recess 44 by the thumb grip 46, but locks the guiding plate 40 and thus the binder in a desired position when the spring-loaded latch is engaged with the intended recess 44. In this embodiment, the locking mechanism 43 operates only one of the opening hinges 30 but it can also operate the other opening hinge synchronously if some kind of link system (not shown) interconnects these two opening hinges 30 so that a thumb grip 46 can operate a latch 45 on the lower opening hinge 30 and another latch on the upper opening hinge in FIGS. 1-3. In addition, more than one locking mechanism 43, for instance two locking mechanisms, i.e. at least one locking mechanism for each opening hinge 30, and more than three desired opening/leafing-through positions, can be used in the binder device 10 according to the invention.

The strips 20a or 20b or the outer sections 32 of the binder device 10 shown in FIGS. 1-9 can be fixed to the inside or outside of the binder by adhesive, screw means, or by being melted into the plastic of the side portions 12 of the binder if the side portions are made of thermoplastic, or by similar fastening means/methods.

All the parts included in the binder device 10 can be blued, varnished, painted, anodised or in some other way coated with a protecting surface, as can be easily understood by a person skilled in the art.

The guiding plate 40 according to the invention can also use three or more link arms 60 to increase stability and facilitate opening and closing of the binder.

The guiding plate can, as already mentioned, be placed flat down, as shown in FIGS. 1-9, in a plane substantially parallel or completely parallel to the plane of the binder back 11.

In another embodiment, the link arms 60 can be elongate component parts formed with a hole at each end 60a, 60b, in which holes fixed pins (not shown) placed on and projecting from the guiding plate 40 and the attachment lugs 33 can be fitted for movable engagement/pivotal attachment of the respective link arm ends 60a, 60b.

1. A device for opening and closing a binder for storing sheets with at least one mechanism arranged in the area of the back of the binder, which mechanism comprises at least two spaced-apart strips for connection to the binder, which strips are movably interconnected by at least one common hinge means,
wherein the mechanism comprises a link means which is movably connected to a centre strip of the hinge means,
that the hinge means comprises two outer strips which are movably connected to its centre strip,
that the outer strips of the hinge means are movably connected to the link means in such manner that the opening and closing motion of the binder produces a simultaneous positively guided motion of the hinge means,
the link means comprising a pivot means which is movably connected to the strips of the hinge means in such manner that the opening/closing motion of the binder produces a positively guided motion of the pivot means and the outer strips of the hinge means,
the pivot means being pivotally connected to the centre strip of the hinge means via a centre axis which is a pivot centre, the centre axis of the pivot means extending substantially transversely to the longitudinal direction of the back of the binder.

2. A device for opening and closing binders as claimed in claim 1, wherein the outer strips of the hinge means are connected to the centre strip of the hinge means by a respective hinge which extends along the back of the binder.

3. A device for opening and closing binders as claimed in claim 1, wherein the pivot means is movably connected to the outer strips of the hinge means via at least one link arm for each outer strip.

4. A device for opening and closing binders as claimed in claim 3, wherein the link arms of the pivot means comprise first ends which are movably connected to the pivot means at different sides of its centre.

5. A device for opening and closing binders as claimed in claim 4, wherein each link arm extends towards the associated outer strip and the second end of each link arm is movably connected to the associated outer strip.

6. A device for opening and closing binders as claimed in claim 4, wherein the pivot means is provided with a pivot centre for each first end of the link arms.

7. A device for opening and closing binders as claimed in claim 1, wherein the link means is a symmetric plate.

8. A device for opening and closing binders as claimed in claim 1, wherein the link means is an asymmetric plate.

9. A device for opening and closing binders as claimed in claim 1, wherein the link means is an elongate component part.

10. A device for opening and closing binders as claimed in claim 4, wherein the link/pivot means comprises the first pivot centre and a pivot centre for each first end of the link arms, said pivot centres being geometrically fixed in relation to each other.

11. A device for opening and closing binders as claimed in claim 1, wherein the link means comprises at least one locking mechanism with at least one recess which is arranged on the circumference of the link means to be engaged with and disengaged from at least one projection which is in operative connection with at least one thumb grip so as to allow stepwise rotation of the link means when disengaging the projection by the thumb grip and to provide locking of the link means and the binder in a desired position when the projection is engaged with the recess.
